(19) United States
(12) Patent Application Publication
(10) Pub. No.: US 2023/0155811 A1
(43) Pub. Date: May 18, 2023

(54) ENCRYPTED INFORMATION SHARING WITH LIGHTWEIGHT DEVICES

(71) Applicant: Micron Technology, Inc., Boise, ID (US)

(72) Inventor: Zhan Liu, Cupertino, CA (US)

(21) Appl. No.: 17/525,004

(22) Filed: Nov. 12, 2021

(51) Int. Cl. H04L 9/08; H04L 9/14; H04L 9/30; H04L 9/32

(52) U.S. Cl. CPC H04L 9/0825; H04L 9/085; H04L 9/14; H04L 9/3066; H04L 9/3242

(57) ABSTRACT

The disclosure relates to secure communications using cryptography. A method is disclosed that includes receiving a public key of a recipient; generating, by a sender, a symmetric key based on the public key of the recipient; encrypting, by a sender, a message using the symmetric key to generate an encrypted message; and transmitting a second public key of the sender and the encrypted message to the recipient.

### FIELD OF THE TECHNOLOGY

At least some embodiments disclosed herein relate generally to semiconductor devices and, in particular, to improving secure communications using Flash memory devices.

### BACKGROUND

Some memory devices may store cryptographic keys to perform cryptographic operations. During a secure communications session, two parties to the session may be required to perform various asymmetric cryptographic operations (e.g., key generation, encryption, decryption, etc.). When one device is low-powered or lacking resources, such operations may be infeasible or impossible.

### BRIEF DESCRIPTION OF THE DRAWINGS

FIG. 1 is a block diagram of a memory device according to some of the example embodiments.

FIG. 2 is a flow diagram illustrating a method for generating and transmitting an encrypted message according to some of the example embodiments.

FIG. 3 is a flow diagram illustrating a method for decrypting an encrypted message according to some of the example embodiments.

FIG. 4 is a flow diagram illustrating a method for generating and transmitting an encrypted message according to some of the example embodiments.

FIG. 5 is a flow diagram illustrating a method for decrypting an encrypted message according to some of the example embodiments.

FIG. 6 is a block diagram illustrating a memory system according to some of the example embodiments.

FIG. 7 is a block diagram illustrating a computing device showing an example embodiment of a computing device according to some of the example embodiments.

### DETAILED DESCRIPTION

Many existing systems secure information using public-key cryptography. In public-key cryptography, each user creates a public and private key pair. To secure information, a first user provides their public key to a second user. The second user can then encrypt a message to send using the first user's public key. Since only the corresponding private key (kept secret by the first user) can decrypt the message, the encryption ensures confidentiality. In addition to encryption, the second user can digitally sign the message using their private key and provide the encrypted, signed message along with their public key to the first user (either directly or via a third-party such as a certificate authority). The first user can verify the digital signature using the second user's public key and then decrypt the message using their own private key.

As illustrated in the above example, in a public-key cryptography system, multiple asymmetric key encryption and decryption operations are needed. First, the second user must encrypt the message. Second, the second user must generate a digital signature which entails implicit encryption of a hash of the underlying message. Third, the first user must verify the digital signature. Fourth, the first user must decrypt the encrypted message. These cryptographic operations are generally time and resource-intensive and may not be possible or practical in lightweight electronic devices such as Internet-of-Things (IoT) devices.

The example embodiments described herein remedy these and other problems in the current state of the art of secure communications.

In the various embodiments, a memory device is disclosed. The memory device includes a storage array that stores data. The storage array can include a dedicated area for storing cryptographic keys. The cryptographic keys can comprise asymmetric key pairs, such as an elliptic curve key pair. In some embodiments, the memory device can include software, firmware, hardware, or a combination thereof for generating cryptographic keys. Alternatively, or in conjunction with the foregoing, the memory device can be configured to receive such cryptographic keys over an interface and persist the cryptographic keys to the storage array. In some embodiments, the memory device can include a physically unclonable function (PUF). In these embodiments, the memory device can use the PUF to seed a key generation process.

The above-described memory device can then be used in communications processes, as described in more detail below. As will be discussed, the communications process can include various cryptographic operations (e.g., key generation, encryption, decryption, etc.). In some embodiments, these cryptographic operations can be performed by the memory device (e.g., via firmware and/or a cryptographic processor). In other embodiments, some or all of the cryptographic operations can be performed by an external computing device (e.g., host processor).

In an embodiment, the operations can include receiving a public key of a recipient; generating, by a sender, a symmetric key based on the public key of the recipient; encrypting, by a sender, a message using the symmetric key to generate an encrypted message; and transmitting a second public key of the sender and the encrypted message to the recipient.

In an embodiment, the public key of the recipient comprises an elliptic curve cryptography (ECC) public key, and the second public key of the sender comprises a second ECC public key. In an embodiment, generating the symmetric key by sender comprises generating the symmetric key using recipient ECC public key and the ECC private key of the sender, the ECC private key of the sender corresponding to the second ECC public key. In an embodiment, the operations can further include re-calculating, by the recipient, a second symmetric key using an ECC private key of the recipient and the second public key; and decrypting the encrypted message using the second symmetric key. In an embodiment, the operations can further include encrypting, by the sender, the symmetric key using the public key of the recipient to generate an encrypted symmetric key; signing, by the sender, the symmetric key using a private key of the sender to generate a digital signature; and transmitting the digital signature and the encrypted symmetric key to the recipient along with the second public key of the sender and the encrypted message. Although ECC is used as an example, the disclosure is not limited as such and other cryptosystems, such as Rivest-Shamir-Adleman (RSA), may be used.

In an embodiment, the operations can further include validating the digital signature using the second public key of the sender, decrypting the encrypted symmetric key using a private key of the recipient to obtain a decrypted symmetric key, and decrypting the encrypted message using the decrypted symmetric key. In an embodiment, the operations can further include generating a message authentication code (MAC) using the symmetric key and transmitting the MAC to the recipient along with the second public key of the sender and the encrypted message.

These and various other embodiments are described in more detail below.

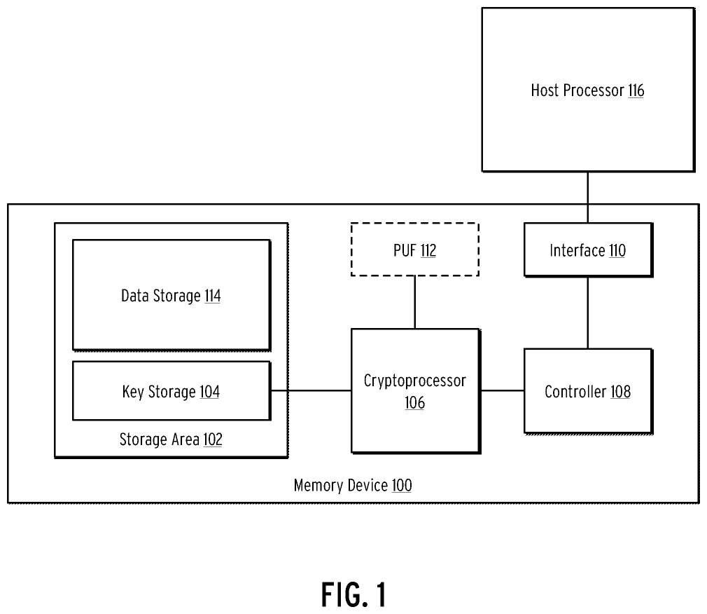

FIG. 1 is a block diagram of a memory device according to some of the example embodiments.

In the illustrated embodiment, a memory device 100 is communicatively coupled to a host processor 116 via an interface 110. The memory device 100 includes various components (implemented as hardware, software, or combinations thereof), including a cryptoprocessor 106, a controller 108, a PUF 112, and a storage array 102. In some embodiments, the storage array 102 can include a data storage region 114 and a dedicated key storage region 104.

In the illustrated embodiment, the memory device 100 can comprise any persistent memory device such as a Flash storage device or other solid-state storage devices. The memory device 100 can include a storage array 102 or another type of storage partition that persistently stores data. As illustrated, this storage array can include a key storage region 104. In some embodiments, the key storage region 104 can comprise a dedicated area of a larger storage array. Thus, as illustrated, non-key data can be stored in the data storage region 114. In other embodiments, the key storage region 104 can comprise a smaller dedicated storage area. In some embodiments, the key storage region 104 can be write-protected and only writeable via a secure command. In an embodiment, a secure command comprises a signed command. In some embodiments, the signed command includes a signature generated using a key corresponding to a key stored in key storage region 104. In an embodiment, the signature is generated using a private key corresponding to a public key stored in key storage region 104. In some embodiments, key storage region 104 can store multiple keys (e.g., public keys).

In an embodiment, a controller 108 can receive and process commands via interface 110. In some embodiments, the controller can offload cryptographic operations to cryptoprocessor 106. Examples of cryptographic operations include signature validation, hash calculations, random number generation, encryption, decryption, etc. In some embodiments, a controller can forward commands to cryptoprocessor 106 for cryptographic operations, as will be discussed. In some embodiments, the cryptoprocessor 106 can comprise a dedicated chip such as an application-specific integrated circuit (ASIC), field-programmable gate array (FPGA), or a similar type of circuitry. In some embodiments, cryptoprocessor 106 can be implemented as a secure software element of a processor (e.g., in a secure enclave).

In one embodiment, the memory device 100 can include a PUF 112. In the illustrated embodiment, the PUF 112 may comprise a physical hardware circuit that exploits inherent randomness introduced during manufacturing to give a physical entity a unique ‘fingerprint’ or trust anchor. In the illustrated embodiment, the PUF 112 produces a consistent and repeatable value. In some embodiments, the PUF 112 may comprise a static random-access memory (SRAM) PUF, Delay PUF, or any other PUF technology implemented on the memory device 100. In the illustrated embodiment, the cryptoprocessor 106 can read a PUF value from PUF 112 and use the PUF value during cryptographic operations, as will be discussed.

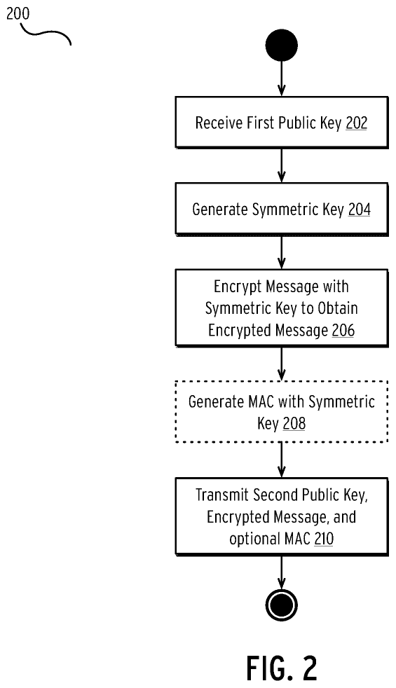

In brief, cryptoprocessor 106 can be configured to perform key generation, encryption, decryption, message authentication code (MAC) generation/validation, and other operations necessary to facilitate secure communications with another device. Details on these operations are provided in the descriptions of FIGS. 2 through 5 and are not repeated herein. In some embodiments, any cryptographic steps in FIGS. 2 through 5 can be performed by cryptoprocessor 106, while non-cryptographic steps can either be executed by cryptoprocessor 106 or controller 108. In some embodiments, the devices involved in the secure communications of FIGS. 2 through 5 can each include a memory device as described with respect to memory device 100. Alternatively, in some embodiments, one or both devices can comprise other types of devices, provided they can perform the operations described herein.

FIG. 2 is a flow diagram illustrating a method 200 for generating and transmitting an encrypted message according to some of the example embodiments. In the illustrated embodiment, method 200 can be executed by a sender (S) of secure communications.

In step 202, method 200 receives a first public key (public_{R}). In some embodiments, the first public key can be the public key of a recipient (R) of a message. In some embodiments, the first public key can comprise an elliptic curve cryptography (ECC) public key. In some embodiments, the first public key is associated with a first private key (private_{R}) held by the recipient. In some embodiments, method 200 can receive the first public key using a key agreement protocol. In some embodiments, a Diffie-Hellman (DH) key exchange protocol can be used. In another embodiment, an Elliptic Curve Diffie-Hellman (ECDH) key exchange protocol can be used.

In step 204, method 200 generates a symmetric key (s_{key}). In some embodiments, method 200 can calculate s_{key} using the first public key (public_{R}) and a second private key (private_{S}). In some embodiments, the second private key is associated with a second key pair (which includes a second public key, public_{S} and the second private key) generated by method 200 (i.e., the sender, S) in advance. In some embodiments, method 200 can generate the symmetric key by multiplying the first public key (public_{R}) and the second private key (private_{S}), thus s_{key}=ƒ(public_{R}, private_{S}), where ƒ represents any function such that ƒ(public_{R},private_{S})=ƒ(private_{R},public_{S}) or the values of ƒ(public_{R},private_{S}) and ƒ(private_{R},public_{S}) can otherwise be compared without secret information. For example, in a Diffie-Hellman cryptosystem, the function ƒ may multiply its inputs over a given field. In some embodiments, the method 200 can generate the symmetric key by multiplying the first public key (public_{R}) and the second private key (private_{S}) and inputting the resulting value into a hash function (e.g., SHA-3, SHA-256, BLAKE2, etc.). In this embodiment, s_{key}=hash(ƒ(public_{R}, private_{S})), where hash represents a well-known and agreed upon (between recipient and sender) hashing algorithm.

In step 206, method 200 encrypts a message using the symmetric key to obtain an encrypted message. In some embodiments, a well-known and agreed upon (between recipient and sender) symmetric encryption algorithm can be used to encrypt the message. In the embodiments, the cleartext message (c) is used as the message, and the symmetric key (s_{key}) is used as the encryption key. Thus, in step 206, method 200 can compute an encrypted message (m) as: m=enc_{sym}(c, s_{key}), where enc_{sym} comprises a well-known and agreed upon (between recipient and sender) symmetric encryption algorithm.

In step 208, method 200 generates a MAC using the symmetric key. In some embodiments, step 208 is optional. In some embodiments, method 200 can compute a MAC using a message and the symmetric key (s_{key}). The message can include either the cleartext message (c) or encrypted message (m). In some embodiments, a hash-based message authentication code (HMAC) algorithm, such as HMAC-SHA256, can be used. Other algorithms such as Cipher-based MAC (CMAC), Galois MAC (GMAC), etc., may also be used. In some embodiments, the MAC in step 208 can be computed as mac=MAC(s_{key}, c|m), where MAC comprises a well-defined and agreed upon MAC function.

In step 210, method 200 transmits a second public key, the encrypted message (from step 206), and the MAC (from step 208, if implemented) to a receiver (R). In some embodiments, method 200 can establish a secure channel, such as a transport layer security (TLS) or secure sockets layer (SSL) channel with the receiver. In such an embodiment, the sender (S) operating method 200 can transmit the second public key (public_{S}), encrypted message (c), and optional MAC (mac) to the receiver (R) using the secure channel.

Since the encrypted message (c) is encrypted using a symmetric key generated using the recipient's public key and sender's private key, the encrypted message can be ensured confidential (i.e., only sender and recipient can decrypt the message). Further, the use of a MAC provides authentication as only the sender can generate a valid MAC.

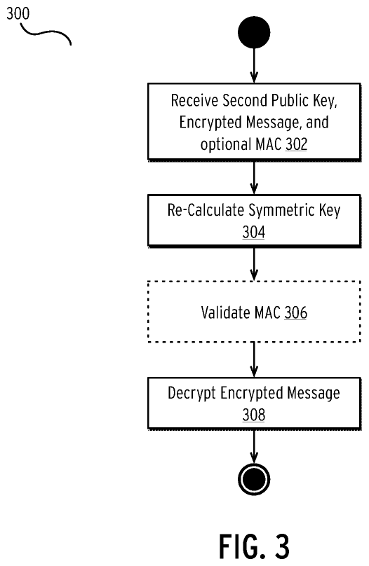

FIG. 3 is a flow diagram illustrating a method for decrypting an encrypted message according to some of the example embodiments.

In step 302, method 300 can include receiving a message that includes a second public key (public_{S}) of a sender, an encrypted message (m) generated by the sender (S), and an optional MAC (mac) generated by a sender (S). FIG. 3 provides further detail on the format and generation of the message contents and is not repeated herein.

In step 304, method 300 can include re-calculating a symmetric key (s_{key,R}) such that s_{key,R}==s_{key}. In some embodiments, method 300 can re-calculate the symmetric key using a process similar to that of step 204 of FIG. 2. In some embodiments, method 300 can calculate s_{key,R} using the second public key (public_{S}) of the sender and the first private key (private_{R}) of the recipient. In some embodiments, the first private key is associated with the first key pair (which includes the first public key, public_{R}, and the first private key) generated by method 300 (i.e., by the recipient, R) in advance. In some embodiments, method 300 can generate the symmetric key by multiplying the second public key (public_{S}) and the first private key (private_{R}), thus s_{key,R}=ƒ(private_{S}, public_{S}). In some embodiments, the method 300 can generate the symmetric key by multiplying the second public key (public_{S}) and the first private key (private_{R}) and inputting the resulting value into a hash function (e.g., SHA-3, SHA-256, BLAKE2, etc.). In this embodiment, s_{key,R}=hash(ƒ(private_{R}, public_{S})), where hash represents a well-known and agreed upon (between recipient and sender) hashing algorithm.

Notably, in the illustrated embodiment, the result of ƒ(private_{R}, public_{S}) and ƒ(public_{R}, private_{S}) may be guaranteed equal by the underlying agreed-upon asymmetric cipher. For example, in an ECC system, private keys of two senders can be represented as integers a and b and an ECC elliptic curve with generator point can be represented as a point G. Public keys corresponding to a and b can then be represented as a*G and b*G, respectively. In such a scenario, the symmetric key (or input to a key generation algorithm) can be represented as s_{key}=(a*G)*b=(b*G)*a or, alternatively, s_{key}=s_{key,R}=public_{R}*private_{S}=prviate_{R}*public_{S}.

In step 306, method 300 can include validating a MAC (if provided). As described in FIG. 2, the MAC can be computed using the encrypted message (m) and a hash-based message authentication code (HMAC) algorithm, such as HMAC-SHA256. In step 306, method 300 can re-compute the MAC using the agreed-upon algorithm (e.g., hash(m)) and compare the computed MAC to the received MAC. If the two MACs are equal, then method 300 can determine that the message is authentic and continue processing. Alternatively, if the MACs are not equal, method 300 can end or, in some embodiments, raise an error. In some embodiments, step 306 is optional. In other embodiments, step 306 can be performed after step 308. In this embodiment, step 306 can comprise computing a hash based on the decrypted message instead of the encrypted message, as discussed in FIG. 2.

In step 308, method 300 can include decrypting the encrypted message (m) using the symmetric key (s_{key,R}). In some embodiments, a well-known and agreed upon (between recipient and sender) symmetric decryption algorithm can be used to decrypt the message. The decryption algorithm can correspond to the encryption algorithm used in step 206 of FIG. 2. In the embodiments, the encrypted message (m) is used as the message, and the symmetric key (s_{key,R}) is used as the decryption key. Thus, in step 308, method 300 can compute a cleartext message (c) as c=dec_{sym}(m,s_{key,R}), where dec_{sym} comprises a well-known and agreed upon (between recipient and sender) symmetric encryption algorithm. After decrypting the message, method 300 can comprise providing the decrypted message to a downstream process for further processing. Such downstream processes can then display the message, perform a further computation or action based on the message, etc., and the specific downstream process is not limited herein.

Using the method embodiments of FIGS. 2 and 3, the example embodiments can replace two asymmetric operations on each end of communication with a single asymmetric cryptographic operation per device. Specifically, each device must only generate the symmetric key. By contrast, in existing schemes, the sender must encrypt a message with a public key and sign the message with a private key, while the received must decrypt the message with a private key and verify the signature with a public key. As such, the example embodiments reduce the time and computational complexity in a secure communications session. Furthermore, information is encrypted and decrypted using a symmetric encryption algorithm which increases the speed of encryption, especially for longer messages due to the complexity of asymmetric encryption algorithms.

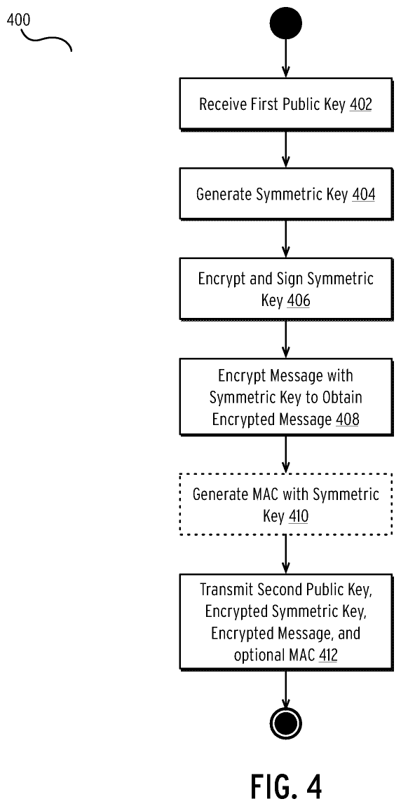

FIG. 4 is a flow diagram illustrating a method for generating and transmitting an encrypted message according to some of the example embodiments.

In step 402, method 400 receives a first public key (public_{R}). In some embodiments, the first public key can be the public key of a recipient (R) of a message. In some embodiments, the first public key can comprise an elliptic curve cryptography (ECC) public key. In some embodiments, the first public key is associated with a first private key (private_{R}) held by the recipient. In some embodiments, method 400 can receive the first public key using a key agreement protocol. In some embodiments, a Diffie-Hellman (DH) key exchange protocol can be used. In another embodiment, an Elliptic Curve Diffie-Hellman (ECDH) key exchange protocol can be used.

In step 404, method 400 generates a symmetric key (s_{key}). In some embodiments, method 400 can calculate s_{key} using the first public key (public_{R}) and a second private key (private_{S}). In some embodiments, the second private key is associated with a second key pair (which includes a second public key, public_{S}) and the second private key) generated by method 400 (i.e., the sender, S) in advance. In some embodiments, method 400 can generate the symmetric key by multiplying the first public key (public_{R}) and the second private key (private_{S}), thus s_{key}=ƒ(public_{R}, private_{S}). In some embodiments, the method 400 can generate the symmetric key by multiplying the first public key (public_{R}) and the second private key (private_{S}) and inputting the resulting value into a hash function (e.g., SHA-3, SHA-256, BLAKE2, etc.). In this embodiment, s_{key}=hash(ƒ(public_{R}, private_{S})), where hash represents a well-known and agreed upon (between recipient and sender) hashing algorithm.

In step 406, method 400 can include encrypting and signing the symmetric key (s_{key}). In an embodiment, step 406 can include encrypting the symmetric key using the public key of the receiver (public_{R}). In some embodiments, the symmetric key can be hashed using a hash function prior to signing. As such, in some embodiments, method 400 can calculate s_{key,e}=enc(s_{key}, public_{R}), where enc can comprise a well-known asymmetric encryption algorithm, such as Elliptic Curve Integrated Encryption Scheme (ECIES) or ECC-based ElGamel encryption. In some embodiments, step 406 can further include signing the symmetric key to generate a signature (sig_{sym}). In some embodiments, step 406 can include signing the symmetric key using the sender's private key (private_{S}). As such, in some embodiments, method 400 can calculate sig_{sym}=sa(s_{key},private_{S}), where sa can comprise a well-known asymmetric signature algorithm, such as an Elliptic Curve Digital Signature Algorithm (ECDSA) or Edwards-curve Digital Signature Algorithm (EdDSA).

In step 408, method 400 encrypts a message using the symmetric key to obtain an encrypted message. In some embodiments, a well-known and agreed upon (between recipient and sender) symmetric encryption algorithm can be used to encrypt the message. In the embodiments, the cleartext message (c) is used as the message, and the symmetric key (s_{key}) is used as the encryption key. Thus, in step 408, method 400 can compute an encrypted message (m) as: m=enc_{sym}(c, s_{key}), where enc_{sym} comprises a well-known and agreed upon (between recipient and sender) symmetric encryption algorithm.

In step 410, method 400 generates a MAC using the symmetric key. In some embodiments, step 410 is optional. In some embodiments, method 400 can compute a MAC using a message and the symmetric key (s_{key}). The message can include either the cleartext message (c) or encrypted message (m). In some embodiments, a hash-based message authentication code (HMAC) algorithm, such as HMAC-SHA256, can be used. Other algorithms such as Cipher-based MAC (CMAC), Galois MAC (GMAC), etc., may also be used. In some embodiments, the MAC in step 410 can be computed as mac=MAC(s_{key}, c|m), where MAC comprises a well-defined and agreed upon MAC function.

In step 412, method 400 transmits a second public key, the encrypted message (from step 406), the encrypted and signed symmetric key (from step 408), and the MAC (from step 410, if implemented) to a receiver (R). In some embodiments, method 400 can establish a secure channel, such as a transport layer security (TLS) or secure sockets layer (SSL) channel with the receiver. In such an embodiment, the sender (S) operating method 400 can transmit the second public key (public_{S}), encrypted message (c), encrypted symmetric key (s_{key,e}) encrypted symmetric key signature (sig_{sym}), and optional MAC (mac) to the receiver (R) using the secure channel.

Sine the encrypted message (c) is encrypted using a symmetric key generated using the recipient's public key and sender's private key, the encrypted message can be ensured confidential (i.e., only sender and recipient can decrypt the message). Further, the use of a MAC provides authentication as only the sender can generate a valid MAC.

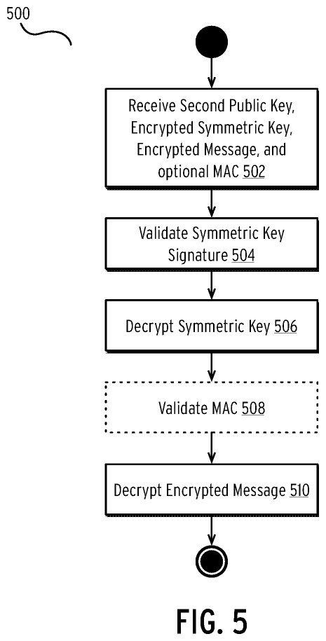

FIG. 5 is a flow diagram illustrating a method for decrypting an encrypted message according to some of the example embodiments.

In step 502, method 500 can include receiving a message that includes the second public key (public_{S}), the encrypted message (m) (from step 406), the encrypted and signed symmetric key (s_{key,e} and sig_{sym}) (from step 408), and the MAC (mac) (from step 410, if implemented) generated by a sender (S). FIG. 4 provides further detail on the format and generation of the message contents and is not repeated herein.

In step 504, method 500 can include validating the signature sig_{sym}. In some embodiments, method 500 can compute its own hash of the encrypted symmetric key using a matching hashing algorithm to that used in step 406. Method 500 can then decrypt (verify) the signature (sig_{sym}) using the public key of the sender (public_{S}) in the message. Method 500 can then determine if the hash and the decrypted signature match. If the two results are equal, then method 500 can determine that the encrypted symmetric key is authentic and continue processing. Alternatively, if the results are not equal, method 500 can end or, in some embodiments, raise an error.

In step 506, method 500 can include decrypting the encrypted symmetric key (s_{key,e}) to obtain the decrypted symmetric key (s_{key}). In the illustrated embodiment, method 500 can use a decryption algorithm corresponding to the decryption algorithm used in step 406. Thus, in step 506, method 500 can use its private key (private_{R}) to decrypt the symmetric key and obtain the decrypted symmetric key.

In step 508, method 500 can include validating a MAC (if provided). As described in FIG. 4, the MAC can be computed using the encrypted message (m) and a hash-based message authentication code (HMAC) algorithm, such as HMAC-SHA256. In step 508, method 500 can re-compute the MAC using the agreed-upon algorithm (e.g., hash(m)) and compare the computed MAC to the received MAC. If the two MACs are equal, then method 500 can determine that the message is authentic and continue processing. Alternatively, if the MACs are not equal, method 500 can end or, in some embodiments, raise an error. In some embodiments, step 508 is optional. In other embodiments, step 508 can be performed after step 508. In this embodiment, step 306 can comprise computing a hash based on the decrypted message instead of the encrypted message, as discussed in FIG. 4.

In step 510, method 500 can include decrypting the encrypted message (m) using the symmetric key (s_{key,R}). In some embodiments, a well-known and agreed upon (between recipient and sender) symmetric decryption algorithm can be used to decrypt the message. The decryption algorithm can correspond to the encryption algorithm used in step 408 of FIG. 4. In the embodiments, the encrypted message (m) is used as the message, and the symmetric key (s_{key,R}) is used as the decryption key. Thus, in step 508, method 500 can compute a cleartext message (c) as: c=dec_{sym}(m,s_{key,R}), where dec_{sym} comprises a well-known and agreed upon (between recipient and sender) symmetric encryption algorithm. After decrypting the message, method 500 can comprise providing the decrypted message to a downstream process for further processing. Such downstream processes can then display the message, perform a further computation or action based on the message, etc., and the specific downstream process is not limited herein.

Using the method embodiments of FIGS. 4 and 5, the example embodiments can replace two asymmetric operations on each end of communication with a single asymmetric cryptographic operation per device. Specifically, each device must only generate the symmetric key. By contrast, in existing schemes, the sender must encrypt a message with a public key and sign the message with a private key, while the received must decrypt the message with a private key and verify the signature with a public key. As such, the example embodiments reduce the time and computational complexity in a secure communications session. Furthermore, information is encrypted and decrypted using a symmetric encryption algorithm which increases the speed of encryption, especially for longer messages due to the complexity of asymmetric encryption algorithms.

The methods and devices described above can be used in, for example, Internet-of-Things (IoT) devices. Such devices have limited computation power (e.g., memory, processing speed, power consumption, etc.). Thus, the reduction of processing time in such devices directly and positively impacts the performance of the devices. Similarly, the example embodiments can be used in mobile devices (e.g., cellular phones), which also have, for example, limited battery capacity. As such, the example embodiments will save power consumption during secure communications. Finally, even for devices with little or no resource limitations (e.g., industrial server computers) and with long messages, the time and resource usage saved will also provide tangible benefits to such devices.

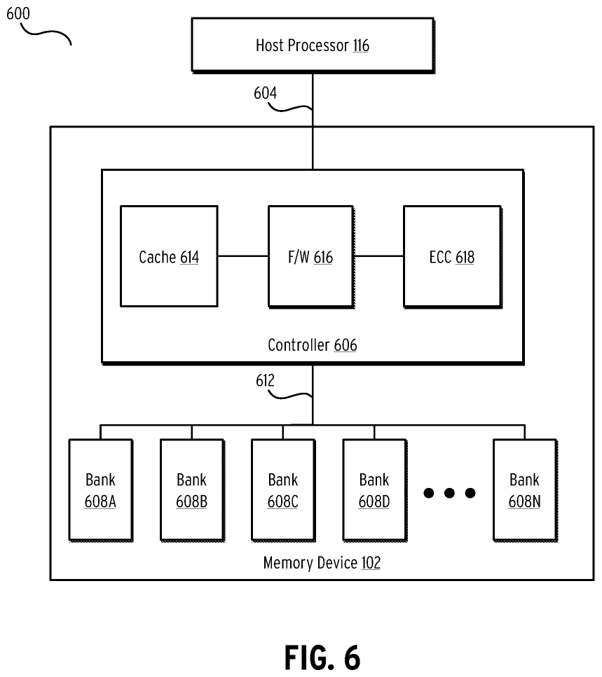

FIG. 6 is a block diagram illustrating a memory system according to some embodiments of the disclosure.

As illustrated in FIG. 6, a computing system 600 includes a host processor 116 communicatively coupled to a memory device 100 via a bus 604. The memory device 100 comprises a controller 606 communicatively coupled to one or more memory banks (e.g., bank 608A, bank 608B, bank 608C, bank 608D, bank 608N, etc.) forming a memory array via an interface 612. As illustrated, the controller 606 includes a local cache 614, firmware 616, and an ECC module 618.

In the illustrated embodiment, host processor 116 can comprise any type of computer processor, such as a central processing unit (CPU), graphics processing unit (GPU), or other types of general-purpose or special-purpose computing devices. The host processor 116 includes one or more output ports that allow for the transmission of address, user, and control data between the host processor 116 and the memory device 100. In the illustrated embodiment, this communication is performed over the bus 604. In one embodiment, the bus 604 comprises an input/output (I/O) bus or a similar type of bus.

The memory device 100 is responsible for managing one or more memory banks (e.g., bank 608A, bank 608B, bank 608C, bank 608D, bank 608N, etc.). In one embodiment, the memory banks (e.g., bank 608A, bank 608B, bank 608C, bank 608D, bank 608N, etc.) comprise NAND Flash dies or other configurations of non-volatile memory. In one embodiment, the memory banks (e.g., bank 608A, bank 608B, bank 608C, bank 608D, bank 608N, etc.) comprise a memory array.

The memory banks (e.g., bank 608A, bank 608B, bank 608C, bank 608D, bank 608N, etc.) are managed by the controller 606. In some embodiments, the controller 606 comprises a computing device configured to mediate access to and from banks (e.g., bank 608A, bank 608B, bank 608C, bank 608D, bank 608N, etc.). In one embodiment, the controller 606 comprises an ASIC or other circuitry installed on a printed circuit board housing the memory banks (e.g., bank 608A, bank 608B, bank 608C, bank 608D, bank 608N, etc.). In some embodiments, the controller 606 may be physically separate from the memory banks (e.g., bank 608A, bank 608B, bank 608C, bank 608D, bank 608N, etc.). The controller 606 communicates with the memory banks (e.g., bank 608A, bank 608B, bank 608C, bank 608D, bank 608N, etc.) over the interface 612. In some embodiments, this interface 612 comprises a physically wired (e.g., traced) interface. In other embodiments, the interface 612 comprises a standard bus for communicating with memory banks (e.g., bank 608A, bank 608B, bank 608C, bank 608D, bank 608N, etc.).

The controller 606 comprises various modules including local cache 614, firmware 616 and ECC module 618. In one embodiment, the various modules (e.g., local cache 614, firmware 616 and ECC module 618) comprise various physically distinct modules or circuits. In other embodiments, the modules (e.g., local cache 614, firmware 616 and ECC module 618) may completely (or partially) be implemented in software or firmware.

As illustrated, firmware 616 comprises the core of the controller and manages all operations of the controller 606. The firmware 616 may implement some or all of the methods described above. Specifically, the firmware 616 may implement the methods described in the foregoing figures.

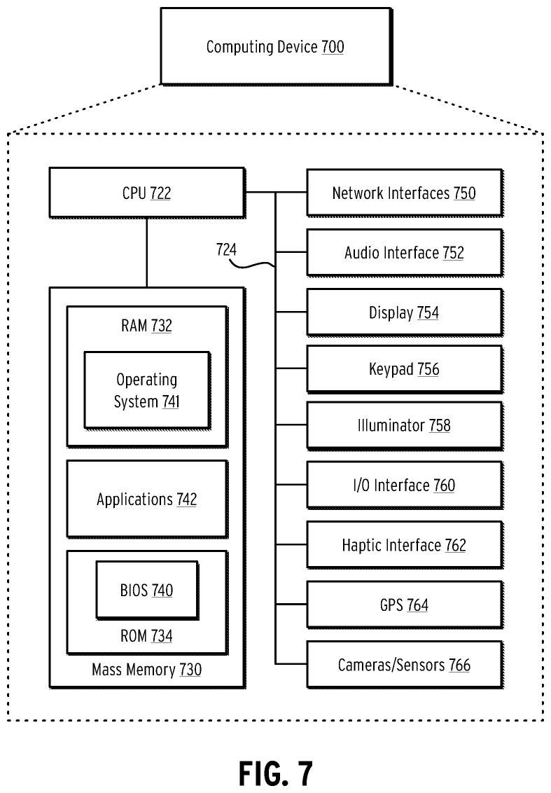

FIG. 7 is a block diagram illustrating a computing device 700 showing an example embodiment of a computing device used in the various embodiments of the disclosure.

The computing device 700 may include more or fewer components than those shown in FIG. 7. For example, a server computing device may not include audio interfaces, displays, keypads, illuminators, haptic interfaces, GPS receivers, cameras, or sensors.

As shown in the figure, the computing device 700 includes a processing unit such as CPU 722 in communication with a mass memory 730 via a bus 724. The computing device 700 also includes one or more network interfaces 750, an audio interface 752, a display 754, a keypad 756, an illuminator 758, an input/output interface 760, a haptic interface 762, a Global Positioning System transceiver (GPS transceiver 764) and one or more sensors 766, such as cameras or other optical, thermal, or electromagnetic. The positioning of the one or more sensors 766 on the computing device 700 can change per computing device 700 model, per computing device 700 capabilities, and the like, or some combination thereof.

The computing device 700 may optionally communicate with a base station (not shown) or directly with another computing device. A network interface is sometimes known as a transceiver, transceiving device, or network interface card (NIC).

The audio interface 752 produces and receives audio signals such as the sound of a human voice. For example, the audio interface 752 may be coupled to a speaker and microphone (not shown) to enable telecommunication with others or generate an audio acknowledgment for some action. Display 754 may be a liquid crystal display (LCD), gas plasma, light-emitting diode (LED), or any other type of display used with a computing device. Display 754 may also include a touch-sensitive screen arranged to receive input from an object such as a stylus or a digit from a human hand.

Keypad 756 may comprise any input device arranged to receive input from a user. Illuminator 758 may provide a status indication or provide light.

The computing device 700 also comprises input/output interface 760 for communicating with external devices, using communication technologies, such as USB, infrared, Bluetooth™, or the like. The haptic interface 762 provides tactile feedback to a user of the client device.

The GPS transceiver 764 can determine the physical coordinates of the computing device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS, or the like, to further determine the physical location of the computing device 700 on the surface of the Earth. In one embodiment, however, the computing device 700 may, through other components, provide other information that may be employed to determine a physical location of the device, including, for example, a MAC address, Internet Protocol (IP) address, or the like.

Mass memory 730 includes a RAM 732, a ROM 734, and other storage means. Mass memory 730 illustrates another example of computer storage media for storage of information such as computer-readable instructions, data structures, program modules, or other data. Mass memory 730 stores a basic input/output system (BIOS 740) for controlling the low-level operation of the computing device 700. The mass memory also stores an operating system 741 for controlling the operation of the computing device 700

Applications 742 may include computer-executable instructions which, when executed by the computing device 700, perform any of the methods (or portions of the methods) described previously in the description of the preceding Figures. In some embodiments, the software or programs implementing the method embodiments can be read from hard disk drive (not illustrated) and temporarily stored in RAM 732 by CPU 722. CPU 722 may then read the software or data from RAM 732, process them, and store them to RAM 732 again.

The disclosure includes various devices which perform the methods and implement the systems described above, including data processing systems which perform these methods, and computer-readable media containing instructions which, when executed on data processing systems, cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to “one” or “an” embodiment in the present disclosure do not necessarily reference the same embodiment and such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments, but not other embodiments.

In this description, various functions and operations may be described as being performed by or caused by software code to simplify description. However, those skilled in the art will recognize what is meant by such expressions is that the functions result from the execution of the code by one or more processors, such as a microprocessor, Application-Specific Integrated Circuit (ASIC), graphics processor, or a Field-Programmable Gate Array (FPGA). Alternatively, or in combination, the functions and operations can be implemented using special-purpose circuitry (e.g., logic circuitry), with or without software instructions. Embodiments can be implemented using hardwired circuitry without software instructions or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of machine or computer-readable media used to effect distribution.

At least some aspects disclosed can be embodied, at least in part, in software. That is, the techniques may be carried out in a computing device or other system in response to its processor, such as a microprocessor, executing sequences of instructions contained in a memory, such as ROM, volatile RAM, non-volatile memory, cache, or a remote storage device.

Routines executed to implement the embodiments may be implemented as part of an operating system, middleware, service delivery platform, SDK (Software Development Kit) component, web services, or other specific application, component, program, object, module, or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which, when executed by a computing device, causes the device to perform various methods. The executable software and data may be stored in various places, including, for example, ROM, volatile RAM, non-volatile memory, or cache. Portions of this software or data may be stored in any one of these storage devices. Further, the data and instructions can be obtained from centralized servers or peer to peer networks. Different portions of the data and instructions can be obtained from different centralized servers or peer to peer networks at different times and in different communication sessions or in the same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read-only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions.

In general, a tangible or non-transitory machine-readable medium includes any mechanism that provides (e.g., stores) information in a form accessible by a machine (e.g., a computer, mobile device, network device, personal digital assistant, manufacturing tool, any device with a set of one or more processors, etc.).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors or mobile devices, a user terminal, a vehicle, a personal communications device, a wearable digital device, an electronic kiosk, a general-purpose computer, an electronic document reader, a tablet, a laptop computer, a smartphone, a digital camera, a residential, domestic appliance, a television, or a digital music player. Additional examples of computing devices include devices that are part of what is called “the internet of things” (IoT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or another computing device that includes a memory and a processing device. The host system can include or be coupled to a memory subsystem so that the host system can read data from or write data to the memory subsystem. The host system can be coupled to the memory subsystem via a physical host interface. In general, the host system can access multiple memory subsystems via the same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field-programmable gate array (FPGA), an application-specific integrated circuit (ASIC), etc.), a system on a chip (SoC), or another suitable processor.

Although some of the drawings illustrate a number of operations in a particular order, operations which are not order-dependent may be reordered, and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

We claim:

1. A system comprising:
a processor configured to:
receive a public key of a recipient;
generate, by a sender, a symmetric key based on the public key of the recipient;
encrypt, by a sender, a message using the symmetric key to generate an encrypted message; and
transmit a second public key of the sender and the encrypted message to the recipient.

2. The system of claim 1, wherein the public key of the recipient comprises an elliptic curve cryptography (ECC) public key and the second public key of the sender comprises a second ECC public key.

3. The system of claim 1, wherein generating the symmetric key comprises generating the symmetric key using the public key of the recipient and a private key of the sender, the private key of the sender corresponding to the second public key.

4. The system of claim 3, further comprising a second processor configured to:
re-calculate a second symmetric key using a private key of the recipient and the second public key; and
decrypting the encrypted message using the second symmetric key.

5. The system of claim 1, the processor further configured to:
encrypt, by the sender, the symmetric key using the public key of the recipient to generate an encrypted symmetric key;
sign, by the sender, the symmetric key using a private key of the sender to generate a digital signature; and
transmit the digital signature and the encrypted symmetric key to the recipient along with the second public key of the sender and the encrypted message.

6. The system of claim 5, further comprising a second processor configured to:
validate the digital signature using the second public key of the sender;
decrypt the encrypted symmetric key using a private key of the recipient to obtain a decrypted symmetric key; and
decrypt the encrypted message using the decrypted symmetric key.

7. A method comprising:
receiving a public key of a recipient;
generating, by a sender, a symmetric key based on the public key of the recipient;
encrypting, by a sender, a message using the symmetric key to generate an encrypted message; and
transmitting a second public key of the sender and the encrypted message to the recipient.

8. The method of claim 7, wherein the public key of the recipient comprises an elliptic curve cryptography (ECC) public key and the second public key of the sender comprises a second ECC public key.

9. The method of claim 8, wherein generating the symmetric key comprises generating the symmetric key using the public key of the recipient and a private key of the sender, the private key of the sender corresponding to the second public key.

10. The method of claim 9, further comprising:
re-calculating, by the recipient, a second symmetric key using a private key of the recipient and the second public key; and
decrypting the encrypted message using the second symmetric key.

11. The method of claim 7, further comprising:
encrypting, by the sender, the symmetric key using the public key of the recipient to generate an encrypted symmetric key;
signing, by the sender, the symmetric key using a private key of the sender to generate a digital signature; and
transmitting the digital signature and the encrypted symmetric key to the recipient along with the second public key of the sender and the encrypted message.

12. The method of claim 11, further comprising:
validating the digital signature using the second public key of the sender;
decrypting the encrypted symmetric key using a private key of the recipient to obtain a decrypted symmetric key; and
decrypting the encrypted message using the decrypted symmetric key.

13. The method of claim 7, further comprising generating a message authentication code (MAC) using the symmetric key and transmitting the MAC to the recipient along with the second public key of the sender and the encrypted message.

14. A non-transitory computer-readable storage medium for tangibly storing computer program instructions capable of being executed by a computer processor, the computer program instructions defining steps of:
receiving a public key of a recipient;
generating, by a sender, a symmetric key based on the public key of the recipient;
encrypting, by a sender, a message using the symmetric key to generate an encrypted message; and
transmitting a second public key of the sender and the encrypted message to the recipient.

15. The non-transitory computer-readable storage medium of claim 14, wherein the public key of the recipient comprises an ECC public key and the second public key of the sender comprises a second ECC public key.

16. The non-transitory computer-readable storage medium of claim 15, wherein generating the symmetric key comprises generating the symmetric key using the public key of the recipient and a private key of the sender, the private key of the sender corresponding to the second public key.

17. The non-transitory computer-readable storage medium of claim 16, the steps further comprising:
re-calculating, by the recipient, a second symmetric key using a private key of the recipient and the second public key; and
decrypting the encrypted message using the second symmetric key.

18. The non-transitory computer-readable storage medium of claim 14, the steps further comprising:
encrypting, by the sender, the symmetric key using the public key of the recipient to generate an encrypted symmetric key;
signing, by the sender, the symmetric key using a private key of the sender to generate a digital signature; and
transmitting the digital signature and the encrypted symmetric key to the recipient along with the second public key of the sender and the encrypted message.

19. The non-transitory computer-readable storage medium of claim 18, the steps further comprising:
validating the digital signature using the second public key of the sender;
decrypting the encrypted symmetric key using a private key of the recipient to obtain a decrypted symmetric key; and
decrypting the encrypted message using the decrypted symmetric key.

20. The non-transitory computer-readable storage medium of claim 14, the steps further comprising generating a message authentication code (MAC) using the symmetric key and transmitting the MAC to the recipient along with the second public key of the sender and the encrypted message.
